(19) United States
(12) Patent Application Publication
(10) Pub. No.: US 2018/0074960 A1
(43) Pub. Date: Mar. 15, 2018

(54) Multi-CPU Device with Tracking of Cache-Line Owner CPU

(71) Applicant: Marvell World Trade Ltd., St. Michael (BB)

(72) Inventor: Moshe Raz, Pardesiya (IL)

(21) Appl. No.: 15/697,466

(22) Filed: Sep. 7, 2017

Related U.S. Application Data
(60) Provisional application No. 62/385,637, filed on Sep. 9, 2016.

(51) Int. Cl. G06F 12/0831; G06F 12/0811; G06F 12/084; G06F 12/0875

(52) U.S. Cl. CPC G06F 12/0831; G06F 12/0811; G06F 12/084; G06F 2212/283; G06F 2212/621; G06F 2212/314; G06F 12/0875

(57) ABSTRACT

A processing apparatus includes multiple Central Processing Units (CPUs) and a coherence fabric. Respective ones of the CPUs include respective local cache memories and are configured to perform memory transactions that exchange cache-lines among the local cache memories and a main memory that is shared by the multiple CPUs. The coherence fabric is configured to identify and record in a centralized data structure, per cache-line, an identity of at most a single cache-line-owner CPU among the subset of CPUs that is responsible to commit the cache-line to the main memory; and to serve at least a memory transaction from among the memory transactions, which pertains to a given cache-line among the cache-lines, based on the identity of the cache-line-owner CPU of the cache-line, as recorded in the centralized data structure.

### CROSS-REFERENCE TO RELATED APPLICATIONS

This application claims the benefit of U.S. Provisional Patent Application 62/385,637, filed Sep. 9, 2016, whose disclosure is incorporated herein by reference.

### FIELD OF THE DISCLOSURE

The present disclosure relates generally to multi-processor devices, and particularly to methods and systems for cache coherence.

### BACKGROUND

Some computing devices cache data in multiple cache memories, e.g., local caches associated with individual processing cores. Various protocols are known in the art for maintaining data coherence among multiple caches. One popular protocol is the MOESI protocol, which defines five states named Modified, Owned, Exclusive, Shared and Invalid.

The description above is presented as a general overview of related art in this field and should not be construed as an admission that any of the information it contains constitutes prior art against the present patent application.

### SUMMARY

An embodiment that is described herein provides a processing apparatus including multiple Central Processing Units (CPUs) and a coherence fabric. Respective ones of the CPUs include respective local cache memories and are configured to perform memory transactions that exchange cache-lines among the local cache memories and a main memory that is shared by the multiple CPUs. The coherence fabric is configured to identify and record in a centralized data structure, per cache-line, an identity of at most a single cache-line-owner CPU among the subset of CPUs that is responsible to commit the cache-line to the main memory; and to serve at least a memory transaction from among the memory transactions, which pertains to a given cache-line among the cache-lines, based on the identity of the cache-line-owner CPU of the cache-line, as recorded in the centralized data structure.

In some embodiments, the memory operation includes a request for the cache-line by a requesting CPU, and the coherence fabric is configured to serve the request by instructing the cache-line-owner CPU to provide the cache-line to the requesting CPU. In an embodiment, the coherence fabric is configured to request only the cache-line-owner CPU to provide the cache-line, regardless of whether one or more additional copies of the cache-line are cached by one or more other CPUs. In another embodiment, the memory operation includes committal of the cache-line to the main memory, and the coherence fabric is configured to serve the memory transaction by instructing the cache-line-owner CPU to commit the cache-line.

In a disclosed embodiment, the coherence fabric is configured to identify and record in the centralized data structure, per cache-line, a respective subset of the CPUs that hold the cache-line in their respective local cache memories. In an example embodiment, the coherence fabric is configured to identify the identity of the cache-line-owner CPU for a respective cache-line by monitoring one or more of the memory transactions performed by the multiple CPUs on the cache-line.

There is additionally provided, in accordance with an embodiment that is described herein, a processing method including performing memory transactions that exchange cache-lines among multiple local cache memories of multiple respective Central Processing Units (CPUs) and a main memory that is shared by the multiple CPUs. Per cache-line, at most a single cache-line-owner CPU among the subset of CPUs, which is responsible to commit a valid copy of the cache-line to the main memory, is identified and recorded in a centralized data structure. At least a memory transaction from among the memory transactions, which pertains to a given cache-line among the cache-lines, is served based on the identity of the cache-line-owner CPU of the cache-line, as recorded in the centralized data structure.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a multi-CPU processor, in accordance with an embodiment that is described herein;

FIG. 2 is a state diagram that schematically illustrates a process for cache-line state tracking in the multi-CPU processor of FIG. 1, in accordance with an embodiment that is described herein; and

FIGS. 3A-3C are diagrams that schematically illustrate an example cache-line management flow in the multi-CPU processor of FIG. 1, in accordance with an embodiment that is described herein.

### DETAILED DESCRIPTION OF EMBODIMENTS

Embodiments that are described herein provide improved techniques for maintaining data coherence in systems that comprise multiple cache memories. In some embodiments, a multi-CPU processor comprises multiple Central Processing Units (CPUs) that access a shared main memory. Some of the CPUs comprise respective local cache memories. The CPUs are configured to perform memory transactions that exchange cache-lines among the local cache memories and the main memory.

In order to maintain data coherence amongst the CPUs and their local caches, and with the main memory, the multi-CPU processor further comprises a hardware-implemented coherence fabric, in an embodiment. The coherence fabric is configured to monitor the memory transactions exchanged between the CPUs and the main memory, and, based on the monitored memory transactions, to perform actions such as selectively invalidating cache-lines stored on one or more caches, and instructing CPUs to transfer cache-lines between one another or commit cache-lines to the main memory.

In some embodiments, based on the monitored memory transactions, the coherence fabric (i) identifies, per cache-line, a subset of CPUs that hold the cache-line in their respective local cache memories, and (ii) identifies, per cache-line, the identity of at most a single cache-line-owner CPU that is responsible to perform an operation on a valid copy of the cache-line, for example commit the valid cache-line to the main memory or cause the cache-line to be provided to another CPU that requests the cache-line. The coherence fabric typically records the identity of the cache-line owner CPU, per cache-line, along with the subset of CPUs holding the cache-line, in a centralized data structure referred to as a “Snoop Filter.”

By recording the identity of the cache-line-owner CPU in a central data structure, the disclosed techniques reduce the latency of memory transactions. For example, when a CPU requests a cache-line, the coherence fabric does not need to collect copies of the cache-line from all the CPUs that hold the cache-line. Instead, in an embodiment, the coherence fabric instructs only the cache-line-owner CPU to provide the cache-line to the requesting CPU. In this manner, latency is reduced and timing races are avoided.

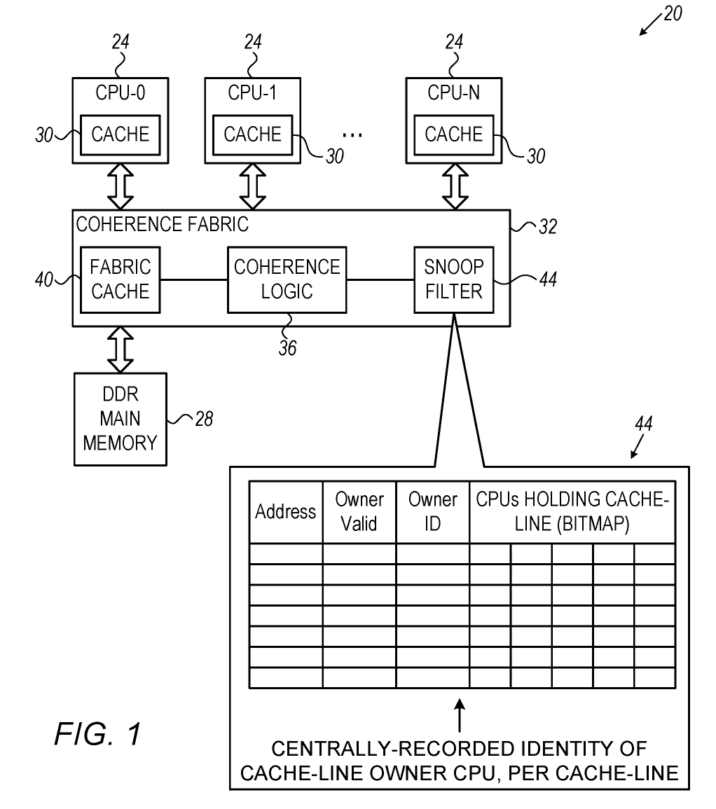

FIG. 1 is a block diagram that schematically illustrates a multi-CPU processor 20, in accordance with an embodiment that is described herein. Processor 20 comprises multiple Central Processing Units (CPUs) 24, denoted CPU-0, CPU-1, . . . , CPU-N. CPUs 24 are also referred to as masters, and the two terms are used interchangeably herein.

Processor 20 further comprises a main memory 28, in the present example a Double Data Rate Synchronous Dynamic Random-Access Memory (DDR SDRAM). Main memory 28 is shared among CPUs 24, in the sense that the various CPUs store data in the main memory and read data from the main memory.

In an embodiment, one or more of CPUs 24 (in the present example all the CPUs) are associated with respective local caches 30. A certain CPU 24 typically uses its local cache 30 for temporary storage of data. A CPU 24 may, for example, read data from main memory 28, store the data temporarily in local cache 30, modify the data, and later write the modified data back to main memory 28. In some embodiments, although a CPU 24 is most closely-coupled to its respective local cache 30, a CPU 24 is also configured to request the coherence fabric to access (“snoop”) other caches 30 associated with other CPUs 24, if necessary. This capability is useful, for example, for accessing cache-lines that are not available in the local cache. The latency of accessing a cache of another CPU is typically higher than the latency of accessing the local cache, but still considerably lower than the latency of accessing the main memory.

In many practical scenarios, two or more of CPUs 24 access the same data. As such, multiple CPUs 24 may hold multiple copies of the same data at the same time in their local caches 30, in an embodiment, in order to maintain coherency among the different caches in the multi-CPU processor system. Moreover, any of these CPUs 24 may access the data in a local or non-local cache, modify the data and/or attempt to write the data back to main memory 28. Such distributed data access, unless managed properly, has the potential of causing data inconsistencies.

In order to maintain data coherence amongst caches 30 of CPUs 24, and with main memory 28, processor 20 further comprises a hardware-implemented coherence fabric 32, which tracks and facilitates the caching of data in the various local caches 30 of CPUs 24. Coherence fabric 32 is drawn graphically in FIG. 1 between CPUs 24 and main memory 28. In practice, however, in some embodiments CPUs 24 communicate directly with main memory 28 over a suitable bus, and fabric 32 monitors the memory transactions flowing on the bus.

The basic data unit managed by coherence fabric 32 is referred to as a “cache-line.” A typical cache-line size is in the range of 64-128 bytes, although any other suitable size can be used. Each cache-line is identified by a respective address in main memory 28, typically the base address at which the data of that cache line begins.

In the present example, fabric 32 comprises a coherence logic unit 36, a fabric cache 40, and a Snoop Filter (SF) 44. Coherence logic unit 36 typically comprises hardware-implemented circuitry that tracks the states of the various cache-lines and facilitates coherence among the various caches 30, as described herein. Fabric cache 40 is used by coherence logic unit 36, and possibly by CPUs 24, for caching data. Snoop filter 44 comprises a centralized data structure in which coherence logic unit 36 records information relating to cache coherence, in an embodiment.

Consider a given CPU 24 that caches a given cache-line in a given local cache 30. At a given point in time, the locally cached cache-line may be at one of several possible states with respect to the given CPU. (The terms “a cache-line cached locally by a CPU is in a state X” and “a CPU is in a state X with respect to a locally-cached cache-line” are used interchangeably herein.) The MOESI protocol, for example, specifies five possible states:
Modified: The locally cached cache-line is the only copy of the cache-line existing among caches 30, and the data in the cache-line has been modified relative to the corresponding data stored in main memory 28.
Owned: The locally cached cache-line is one of multiple (two or more) copies of the cache-line existing among caches 30, but the given CPU is the CPU having responsibility to commit the data of the cache-line to the main memory.
Exclusive: The locally cached cache-line is the only copy of the cache-line existing among caches 30, but the data of the cache-line is unmodified (“clean”) relative to the corresponding data stored in main memory 28.
Shared: The locally cached cache-line is one of multiple (two or more) copies of the cache-line existing among caches 30. It is possible for more than one CPU to be in the “shared” state with respect to the same cache-line.
Invalid: The local cache does not hold a valid copy of the cache-line.

As seen in the list above, any cache-line has at most a single CPU 24 in the “Owned” state. This CPU is referred to herein as the “cache-line-owner CPU” (or simply the “owner CPU”) of that cache line. In the present context, the term “owner CPU of a cache-line” means that this CPU is responsible to commit a valid copy of the cache-line to main memory 28. A cached copy of a cache-line that differs from the corresponding data in main memory 28 is referred to as “dirty.” A cached copy of a cache-line that is identical to the corresponding data in main memory 28 is referred to as “clean.” Committing a valid copy (i.e., the most up-to-date copy) of a cache-line to main memory 28 is thus referred to as “cleaning” the data.

Typically, the identity of the owner CPU of a cache-line is defined in a distributed manner by CPUs 24. Coherence logic unit 36 identifies the identity of the owner CPU of a cache-line by monitoring the various read and write requests issued for that cache-line by the various CPUs 24. Coherence logic unit 36 records the owner identity, per cache-line, in the “Owner ID” field of the entry of the cache-line in snoop filter 44.

The structure of snoop filter 44, in accordance with an example embodiment, is shown in an inset at the bottom of FIG. 1. In this example, snoop-filter 44 comprises a respective entry (row) per cache-line. Each snoop-filter entry comprises the following fields:
Address: The address in main memory 28 from which the cache-line was read.
Owner Valid: A bit indicating whether the cache-line has a valid “owner CPU” or not.
Owner ID: An identity of the owner CPU of the cache-line. This field is valid only when the Owner Valid field indicates that a valid owner exists.
CPUs Holding Cache-Line: A list (e.g., in bitmap format) of the (one or more) CPUs that currently hold the cache-line in their local caches 30.

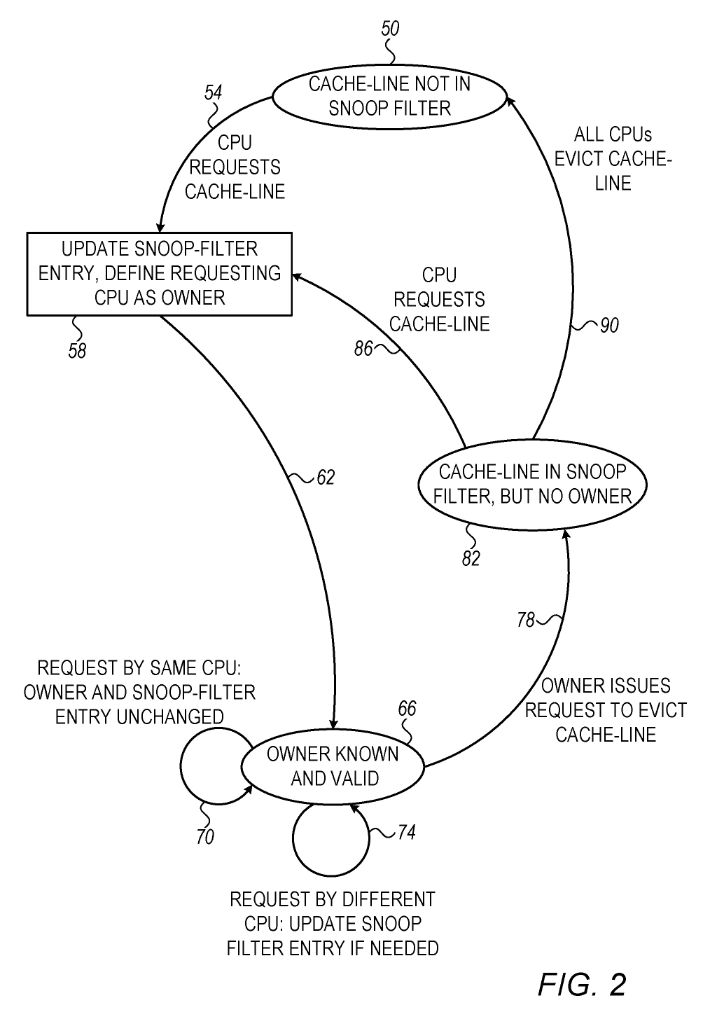

FIG. 2 is a state diagram that schematically illustrates a process for cache-line state tracking in multi-CPU processor 20, in accordance with an embodiment that is described herein. Typically, coherence logic unit 36 maintains, per cache-line, a state machine of this sort that is indicative of the cache-line state.

The life-cycle of a cache-line typically begins in an “Invalid” state 50, in which the cache-line does not have an entry in snoop filter 44. At some point, a certain CPU 24 requests to read the cache-line from main memory 28, as marked by an arrow 54. In response to detecting the read request, coherence logic unit 36 creates an entry in snoop filter 44 for the requested cache-line, at an updating operation 58. In this entry, coherence logic unit 36 records the requesting CPU as holding the cache-line. Since the requesting CPU is defined as the owner of the cache-line, coherence logic unit 36 records the identity of the requesting CPU in the “Owner ID” field of the newly-created entry. The state machine then transitions to an “Owner Known” state 66.

Several transitions are possible from “Owner Known” state 66. If coherence logic unit 36 detects another request from the same CPU 24 to read the cache-line (marked by an arrow 70), no change is needed in the ownership or snoop-filter entry of the cache-line. The state machine remains in “Owner Known” state 66.

If coherence logic unit 36 detects a request from a different CPU 24 to read the cache-line (marked by an arrow 74), coherence logic unit 36 updates the snoop-filter entry of the cache-line if necessary. For example, if the latter CPU does not already hold the cache-line, coherence logic unit 36 updates the “CPUs Holding Cache-Line” field in the snoop-filter entry. (In addition, as will be demonstrated below, if a “cache-line dirty” indication is sent to the requesting CPU, the ownership of the cache-line is changed, and coherence logic 36 records the updated ownership in snoop-filter 44.) In this case, too, the state machine remains in “Owner Known” state 66.

If coherence logic unit 36 detects a request from the owner CPU to evict the cache-line from cache 30 (marked by an arrow 78), the state machine transitions to a “No Owner” state 82. The owner CPU typically requests to evict the cache-line upon writing the cache-line back to main memory 28. In such a case, the cache-line still has an entry in snoop-filter 44, but no valid owner is defined for the cache-line. Coherence logic unit 36 updates the snoop-filter entry to reflect that no valid owner exists.

Two transitions are possible from “No Owner” state 82. If coherence logic unit 36 detects that all CPUs holding the cache-line have requested to evict the cache-line from their local caches 30 (marked by an arrow 90), the state machine transitions back to “Invalid” state 50. If coherence logic unit 36 detects that a certain CPU requests to read the cache-line (marked by an arrow 86), the state machine transitions to updating operation 58.

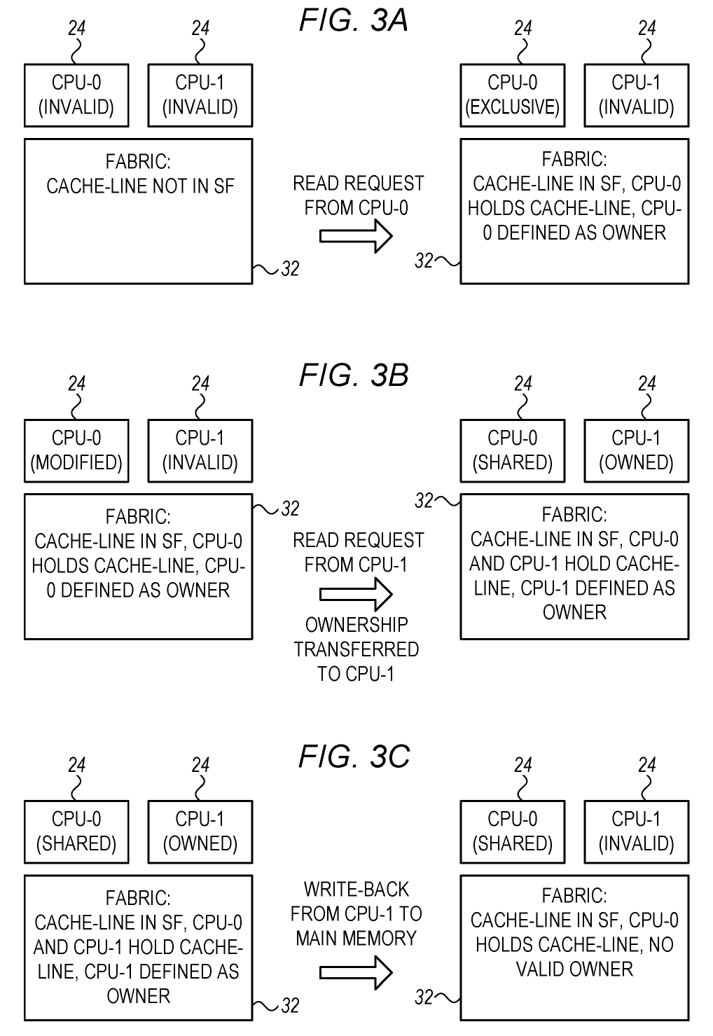

FIGS. 3A-3C are diagrams that schematically illustrate an example cache-line management flow in multi-CPU processor 20, in accordance with an embodiment that is described herein. The example scenario involves two CPUs 24, denoted CPU-0 and CPU-1, and a single cache-line.

The initial state of this example is shown on the left-hand side of FIG. 3A. Initially, the cache-line has no entry in snoop filter 44, and both CPU-0 and CPU-1 are in the “Invalid” state. At some point, coherence logic unit 36 detects that CPU-0 requests to read the cache-line. In response, CPU-0 transitions to the “Exclusive” state, and creates an entry for the cache-line in snoop filter 44. In this entry, coherence logic unit 36 records CPU-0 as the owner of the cache-line. This state is shown on the right-hand side of FIG. 3A.

The current state of CPU-0, CPU-1 and snoop filter 44 is shown on the left-hand side of FIG. 3B. At some later time, coherence logic unit 36 detects that CPU-1 requests to read the cache-line. In such a case, the cache-line owner CPU of the cache-line becomes CPU-1 instead of CPU-0. In response, coherence logic unit changes the “Owner ID” field in the entry of the cache-line to indicate CPU-1 instead of CPU-0. CPU-0 is set to the “Shared” state, and CPU-1 is set to the “Owned” state. Coherence logic unit 36 thus updates the snoop-filter entry of the cache-line to reflect the new owner, and to reflect that CPU-1 holds the cache-line. This state is shown on the right-hand side of FIG. 3B.

The current state of CPU-0, CPU-1 and snoop filter 44 is replicated on the left-hand side of FIG. 3C. At this stage, coherence logic unit 36 detects that CPU-1 requests to write-back the cache-line to main memory 28 and evict the cache-line from its local cache 30. In response, CPU-1 transitions to the “Invalid” state, and CPU-0 transitions to become the owner of the cache-line. Coherence logic 36 again updates snoop filter 44 accordingly. This final state is shown on the right-hand side of FIG. 3C.

The flows illustrated in FIGS. 2 and 3A-3C are example flows that are depicted solely for the sake of clarity. In alternative embodiments, coherence logic unit 36 may carry out the disclosed techniques using any other suitable flow.

The configuration of multi-CPU processor 20, and its components such as CPUs 24 and coherence fabric 32, as shown in FIG. 1, are example configurations that are depicted solely for the sake of clarity. In alternative embodiments, any other suitable configurations can be used. For example, main memory 28 may comprise any other suitable type of memory or storage device. As another example, local caches 30 need not necessarily be physically adjacent to the respective CPUs 24. The disclosed techniques are applicable to any sort of caching performed by the CPUs.

Circuit elements that are not mandatory for understanding of the disclosed techniques have been omitted from the figures for the sake of clarity.

The different elements of multi-CPU processor 20 may be implemented using dedicated hardware or firmware, such as using hard-wired or programmable logic, e.g., in an Application-Specific Integrated Circuit (ASICs) or Field-Programmable Gate Array (FPGA). Caches 30 may comprise any suitable type of memory, e.g., Random Access Memory (RAM).

Some elements of multi-CPU processor 20, such as CPUs 24 and in some cases certain functions of coherence logic unit 36, may be implemented in software on one or more programmable processors. The software may be downloaded to the processors in electronic form, over a network, for example, or it may, alternatively or additionally, be provided and/or stored on non-transitory tangible media, such as magnetic, optical or electronic memory.

It is noted that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A processing apparatus, comprising:
multiple Central Processing Units (CPUs), respective ones of the CPUs comprising respective local cache memories and being configured to perform memory transactions that exchange cache-lines among the local cache memories and a main memory that is shared by the multiple CPUs; and
a coherence fabric, configured to:
identify and record in a centralized data structure, per cache-line, an identity of at most a single cache-line-owner CPU among the subset of CPUs that is responsible to commit the cache-line to the main memory; and
serve at least a memory transaction from among the memory transactions, which pertains to a given cache-line among the cache-lines, based on the identity of the cache-line-owner CPU of the cache-line, as recorded in the centralized data structure.

2. The processing apparatus according to claim 1, wherein the memory operation comprises a request for the cache-line by a requesting CPU, and wherein the coherence fabric is configured to serve the request by instructing the cache-line-owner CPU to provide the cache-line to the requesting CPU.

3. The processing apparatus according to claim 2, wherein the coherence fabric is configured to request only the cache-line-owner CPU to provide the cache-line, regardless of whether one or more additional copies of the cache-line are cached by one or more other CPUs.

4. The processing apparatus according to claim 1, wherein the memory operation comprises committal of the cache-line to the main memory, and wherein the coherence fabric is configured to serve the memory transaction by instructing the cache-line-owner CPU to commit the cache-line.

5. The processing apparatus according to claim 1, wherein the coherence fabric is configured to identify and record in the centralized data structure, per cache-line, a respective subset of the CPUs that hold the cache-line in their respective local cache memories.

6. The processing apparatus according to claim 1, wherein the coherence fabric is configured to identify the identity of the cache-line-owner CPU for a respective cache-line by monitoring one or more of the memory transactions performed by the multiple CPUs on the cache-line.

7. A processing method, comprising:
performing memory transactions that exchange cache-lines among multiple local cache memories of multiple respective Central Processing Units (CPUs) and a main memory that is shared by the multiple CPUs;
identifying and recording in a centralized data structure, per cache-line, at most a single cache-line-owner CPU among the subset of CPUs that is responsible to commit a valid copy of the cache-line to the main memory; and
serving at least a memory transaction from among the memory transactions, which pertains to a given cache-line among the cache-lines, based on the identity of the cache-line-owner CPU of the cache-line, as recorded in the centralized data structure.

8. The processing method according to claim 7, wherein the memory operation comprises a request for the cache-line by a requesting CPU, and wherein serving the request comprises instructing the cache-line-owner CPU to provide the cache-line to the requesting CPU.

9. The processing method according to claim 8, wherein serving the request comprises requesting only the cache-line-owner CPU to provide the cache-line, regardless of whether one or more additional copies of the cache-line are cached by one or more other CPUs.

10. The processing method according to claim 7, wherein the memory operation comprises committal of the cache-line to the main memory, and wherein serving the request comprises instructing the cache-line-owner CPU to commit the cache-line.

11. The processing method according to claim 7, further comprising identifying and recording in the centralized data structure, per cache-line, a respective subset of the CPUs that hold the cache-line in their respective local cache memories.

12. The processing method according to claim 7, wherein identifying the identity of the cache-line-owner CPU for a respective cache-line comprises monitoring one or more of the memory transactions performed by the multiple CPUs on the cache-line.
